(19) United States
(12) Patent Application Publication
(10) Pub. No.: US 2025/0019908 A1
(43) Pub. Date: Jan. 16, 2025

(54) METHOD AND RAIL VEHICLE FOR CARRYING OUT WORK ON A RAILWAY TRACK

(71) Applicant: Plasser & Theurer Export von Bahnbaumaschinen Gesellschaft m.b.H., Vienna (AT)

(72) Inventors: Marc DEMML, Puchenau (AT); Stefan KRENN, Klaffer am Hochficht (AT)

(73) Assignee: Plasser & Theurer Export von Bahnbaumaschinen Gesellschaft m.b.H., Vienna (AT)

(21) Appl. No.: 18/713,277

(22) PCT Filed: Dec. 9, 2022
(86) PCT No.: PCT/EP2022/085089

§ 371 Date: May 24, 2024

(30) Foreign Application Priority Data
Dec. 14, 2021 (AT) A50998/2021

(51) Int. Cl. E01B 27/17; E01B 31/17

(52) U.S. Cl. CPC E01B 27/17; E01B 31/17

(57) ABSTRACT

A method for carrying out work on a railway track by means of a rail vehicle, comprising a track motor vehicle with at least one electrically operable treatment device and an energy supply device for providing electrical energy, as well as a trailer wagon coupled to the track motor vehicle with an energy storage device for providing electrical energy, with the rail vehicle being driven to a track point to be treated, with the trailer wagon being decoupled from the track motor vehicle, and with the track point to be treated being treated by means of the track motor vehicle. Before and/or after treatment by means of the track motor vehicle, the track point is treated by means of the trailer wagon by supplying an electric traction drive of the trailer wagon and a treatment device of the trailer wagon with electrical energy from the energy storage device. In this way, the trailer wagon is used autonomously for track treatment.

### FIELD OF TECHNOLOGY

The invention relates to a method for carrying out work on a railway track by means of a rail vehicle, comprising a track motor vehicle with at least one electrically operable treatment device and an energy supply device for providing electrical energy, as well as a trailer wagon coupled to the track motor vehicle with an energy storage device for providing electrical energy, with the rail vehicle being driven to a track point to be treated, with the trailer wagon being decoupled from the track motor vehicle, and with the track point to be treated being treated by means of the track motor vehicle. The invention further relates to a corresponding rail vehicle.

### PRIOR ART

A generic method and a corresponding rail vehicle are known from DE 10 2019 213 662 A1. The rail vehicle comprises a track motor vehicle and a trailer wagon, with the track motor vehicle having a device for track treatment. The vehicle and the wagon are equipped with their own energy supply device for the provision of electrical energy, with an energy storage device of the track motor vehicle being chargeable from an energy storage device of the trailer wagon. The rail vehicle is uncoupled from the trailer wagon during a treatment operation. In this process, the trailer wagon remains parked on the track.

### PRESENTATION OF THE INVENTION

The object of the invention is to improve a method of the kind mentioned above in such a way that a more flexible and efficient treatment of the track by means of the rail vehicle is made possible. A further object of the invention is to indicate a corresponding rail vehicle.

According to the invention, these objects are achieved by the features of independent claims 1 and 9. Dependent claims indicate advantageous embodiments of the invention.

Before and/or after treatment by means of the track motor vehicle, the track point is treated by means of the uncoupled trailer wagon by supplying an electric traction drive of the trailer wagon and a treatment device of the trailer wagon with electrical energy from the energy storage device. In this way, the trailer wagon is used autonomously for track treatment. This involves carrying out work that is required before and/or after track treatment by means of the track motor vehicle. The vehicle and the wagon use their own energy supply in the uncoupled operating mode, with at least the trailer wagon being operated completely exhaust-free. After the work has been completed, the trailer wagon is recoupled to the track motor vehicle. Thus, two autonomous track maintenance machines can be used for track treatment. Approval-relevant requirements for journeys in the public rail network, on the other hand, apply to the entire rail vehicle because such transfer travels are carried out in coupled operation. Therefore, only the track motor vehicle must be equipped with appropriate equipment for a train protection system (e.g. ETCS) and with train radio equipment.

In a further development of the method, the track motor vehicle is supplied with electrical energy from an overhead contact line via a pantograph, with the track motor vehicle having an electric traction drive. In this way, the track motor vehicle is also operated exhaust-free. An electrical energy storage is usefully arranged in the track motor vehicle to maintain the electrical energy supply in the event of interruptions of the overhead contact line or if the pantograph is lowered at transfer points.

Advantageously, the energy storage device of the trailer wagon is charged in the coupled state via the energy supply device of the track motor vehicle. This allows for a compact design, as no separate supply device is required in the trailer wagon to charge the energy storage device. If the trailer wagon has a particularly space-saving design, the entire charging circuit for the energy storage device is located in the track motor vehicle. In the coupled state, a connection to the energy storage device is established via a suitable charging cable and a charging plug.

In a preferred variant, the trailer wagon designed as a ballast regulating machine is used to produce a desired ballast profile during a track treatment operation. During uncoupled operation, the ballast regulating machine is operated at the required forward speed for dynamic relocation of the ballast grains. Independently of this, the track motor vehicle operates at its own forward speed.

Further advantages of the method arise if sleepers are tamped during a track treatment operation using the track motor vehicle designed as a tamping machine and if the entire tamping machine, in particular, is moved forwards cyclically. A cyclic mode of operation of the tamping machine does not restrict the mode of operation of the uncoupled trailer wagon. It is continuously moved forward, for example to profile or stabilize a ballast bed. Furthermore, a continuous treatment of the rails of the track by means of the trailer wagon is possible independently of the forward movement of the tamping machine. Even if the tamping machine operates continuously with a satellite, independent operation of the trailer wagon is useful because it enables different forward speeds.

In an advantageous operation of the rail vehicle, the trailer wagon is decoupled from the track motor vehicle during a treatment operation by means of an automatically and/or remotely controlled coupling device and is recoupled to the track motor vehicle after track treatment has been carried out. This results in a high degree of flexibility when using both wagons. In a common continuous mode of operation, the coupling remains in place, with the energy storage device of the trailer wagon in particular being charged via the track motor vehicle. At any time, a decoupled mode of operation is possible in between without interrupting the treatment operation. This is ensured by the automatically or remotely controlled coupling process.

In a further improvement, control data is exchanged via a wireless data connection between the track motor vehicle and the trailer wagon, particularly during decoupled operation. This measure enables automated coordination of the work carried out separately by the two wagons.

In a further preferred variant, the entire rail vehicle is supplied with electrical energy from the energy storage device of the trailer wagon during coupled operation. This enables emission-free operation of the entire rail vehicle if no overhead contact line is available and if the track motor vehicle does not have its own energy storage arranged in it. This operating mode also allows optimum utilization of the energy supply device in the track motor vehicle. Load peaks of the electrical consumers are covered by the trailer wagon's electrical energy storage device. A basic load is provided in the track motor vehicle by an internal combustion engine in the optimum speed range or by means of fuel cells with optimum efficiency. This results in an overall optimization of all components of the energy supply system implemented in the rail vehicle.

The rail vehicle according to the invention for carrying out one of the methods described comprises a track motor vehicle with at least one electrically operable treatment device and an energy supply device for providing electrical energy as well as a trailer wagon with an energy storage device for providing electrical energy, with the trailer wagon comprising its own traction drive and its own electrically operable treatment device. In this way, the track motor vehicle and the trailer wagon can be used together in a coupled state and separately from each other for treating a track.

In an advantageous further development, the trailer wagon is designed as a ballast regulating machine, which in particular comprises a centre plough, a shoulder plough, a sweeper brush, and a ballast hopper. A ballast regulating machine of this type is usually not required as a separate wagon travelling on the track throughout a work shift. Therefore, the energy storage device of the ballast regulating machine does not have to be designed for an entire work shift, because charging is carried out in between via the track motor vehicle.

The track motor vehicle is advantageously designed as a tamping machine, which is intended in particular for cyclic forward movement from sleeper to sleeper. An efficient maintenance of a track section can be carried out by means of an appropriate rail vehicle. For example, a trailer wagon designed as a ballast regulating machine is used to shift ballast towards the track centreline before a tamping process. After treatment by the tamping machine, the track is swept and ploughed by the ballast regulating machine to produce a consistent track bed. In another variant, the trailer wagon is designed as a so-called dynamic track stabilizer. This stabilizes the track after a tamping process in order to control settlements caused by train traffic.

A further improvement is characterized by the fact that an automatically and/or remotely controlled coupling device with mechanical connecting elements and with electrical connecting elements is arranged for coupling the trailer wagon to the track motor vehicle and that, in particular, such a coupling device is arranged on both ends of both the track motor vehicle and the trailer wagon. With an appropriate coupling device, no operators are required on the track to decouple and couple the two rail vehicle sections. This increases efficiency and personal safety when carrying out track work with multiple work passes.

In a preferred variant, a central buffer coupler with an electric interface is arranged as a coupling device. Safe solutions for automated mechanical coupling processes are known for this kind of central buffer coupler. During a coupling process, detachable mechanical connecting elements interlock. These mechanical connecting elements are supplemented with detachable electrical connecting elements to form the electric interface for the transmission of electrical energy between the rail vehicle sections.

Advantageously, the track motor vehicle comprises a pantograph for the electrical energy supply from an overhead contact line. If the track to be treated has an active overhead contact line, the entire rail vehicle can be operated exhaust-free, both during coupled operation and during operation separate from each other.

For treating a track without an active overhead contact line or with no overhead contact line, the track motor vehicle usefully comprises an internal combustion engine and a generator coupled thereto for electrical energy supply. This ensures that the rail vehicle can be used flexibly on different tracks.

### BRIEF DESCRIPTION OF THE DRAWINGS

In the following, the invention is explained by way of example with reference to the accompanying figures. The following figures show in schematic illustrations:

FIG. 1 Rail vehicle with trailer wagon in front of the track motor vehicle

FIG. 2 Rail vehicle with trailer wagon behind the track motor vehicle

FIG. 3 Track motor vehicle and trailer wagon in autonomous operation

FIG. 4 Rail vehicle with supply from the energy storage device

FIG. 5 Block diagram of the energy supply

### DESCRIPTION OF THE EMBODIMENTS

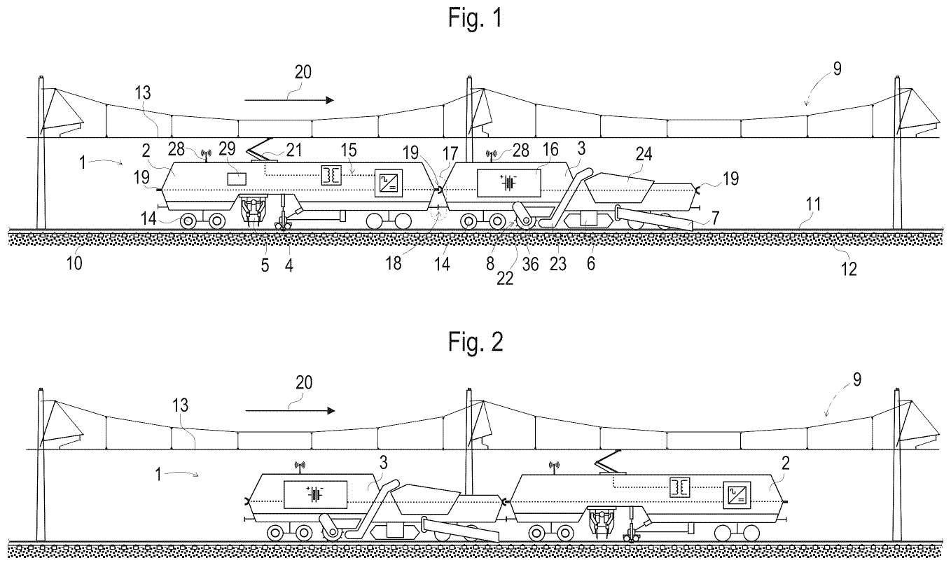

The rail vehicle 1 shown in FIGS. 1 to 4 consists of two sections that can be detached from each other during operation, namely a track motor vehicle 2 and a trailer wagon 3. Each section comprises its own treatment equipment 4-8, which is designed to carry out work on a railway track 9. In the example shown, the track motor vehicle 2 is a tamping machine with a lifting and lining unit 4 and a tamping unit 5. The trailer wagon 3 is a ballast regulating machine with a centre plough 6, a shoulder plough 7, and a sweeping unit 8.

This embodiment of the invention is suitable for maintaining a ballasted track in which a track panel consisting of sleepers 10 and rails 11 attached thereon is supported in a ballast bed 12. The invention also comprises other variants, for example a track motor vehicle 2 and a trailer wagon 3 with a crane and a lifting platform as treatment devices. This allows maintenance of an overhead contact line 13 with different work steps to be carried out. Another example not shown is a tamping machine as a track motor vehicle 2 and a dynamic track stabilizer, a rail grinding machine, or a rail milling machine as a trailer wagon 3.

According to the invention, the track motor vehicle 2 comprises in particular an electric traction drive 14 and an energy supply device 15 for providing electrical energy. The trailer wagon 3 comprises an energy storage device 16, from which an electric traction drive 14 and treatment devices 6, 7, 8 of the trailer wagon 3 are supplied with electrical energy. This means that each section 2, 3 of the rail vehicle 1 can be temporarily used independently for track work.

The trailer wagon 3 is coupled to the track motor vehicle 2 by means of a coupling device 17 for various track work and for transfer travel. In this operating mode, the track motor vehicle 2 and the trailer wagon 3 form integral parts of a track maintenance machine. The coupling device 17 comprises mechanical connecting elements 18 for transmitting traction forces and electrical connecting elements 19 for transmitting electrical energy. As the case may be, pneumatic and hydraulic connecting elements are also included.

Advantageously, the coupling device 17 can be controlled automatically and/or remotely. In this way, a decoupling process and a coupling process can be carried out at any time without interrupting work. For example, the coupling device 17 comprises a central buffer coupler and an electric interface, with detachable connecting elements 18, 19 automatically engaging in one another by means of guiding devices. The detachment of the coupling device 17, for example, takes place by a remote-controlled release of the locks of the connected elements 18, 19. Preferably, such a coupling device 17 is arranged on each end of the track motor vehicle 2 and the trailer wagon 3.

Various operating variants are explained using the examples shown in FIGS. 1 to 4. Here, the rail vehicle 1 consists of a tamping machine and a ballast regulating machine. In FIG. 1, the trailer wagon 3 is coupled to the track motor vehicle 2, with the trailer wagon 3 leading in a working direction 20. The entire rail vehicle 1 is supplied with electrical energy from a live overhead contact line 13 by means of a pantograph 21. In addition to supplying the traction drives 14 and the treatment devices 4-8, the energy storage device 16 is also charged.

The operating mode shown in FIG. 1 is suitable for rearranging ballast for a subsequent tamping process. The shoulder ploughs 7 arranged on both sides transport pre-deposited or surplus ballast towards the track centreline, where further ballast is relocated by means of the centre plough 6. In this way, the sleepers 10 are ballasted so that there is enough ballast to tamp the sleepers 10 for a subsequent track lift.

FIG. 2 also shows the rail vehicle 1 in a coupled state, with the track motor vehicle 1 leading in the working direction 20. The drives are supplied with electrical energy from the overhead contact line 13 and the energy storage device 15 of the trailer wagon 3 is charged. In this operating mode, the sweeping process of the already tamped sleepers 10 is carried out by mwans of the sweeping unit 8, for example. A sweeper brush 22 sweeps excess ballast onto a conveyor belt 23 for transporting it to a ballast hopper 24. Via chutes, this temporarily stored ballast can be placed on track points with a lack of ballast at a later time.

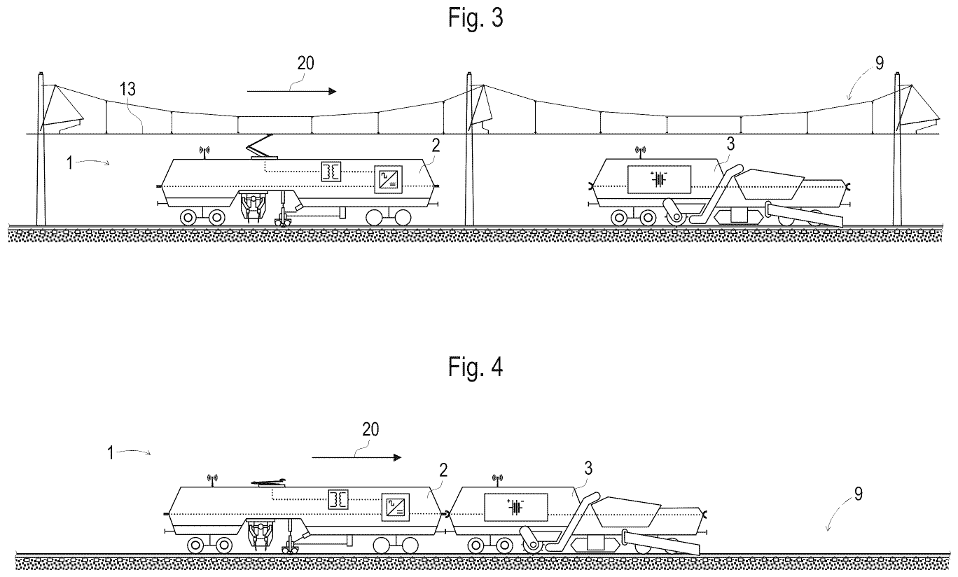

A key aspect of the invention is the possibility to temporarily operate the track motor vehicle 2 and the trailer wagon 3 as independent track maintenance machines. This separate operating mode is shown in FIG. 3. The trailer wagon 3, which is designed as a ballast regulating machine, travels in front of the track motor vehicle 2, which is designed as a tamping machine. Both are operated at different forward speeds, with the tamping machine moving forward cyclically from sleeper 10 to sleeper 10. Independently of this, the ballast regulating machine moves forward at a constant speed. In doing so, the speed must not fall below a minimum speed so that the ploughs 6, 7 provide a dynamic ballast transport.

In this separate operating mode, the trailer wagon 3 is supplied exclusively with electrical energy from the energy storage device 16, while the track motor vehicle 2 can still be supplied via the overhead contact line 13. When the overhead contact line 13 is switched off or absent, the track motor vehicle 2 is operated by an internal combustion engine 25, for example. A generator 26 coupled to the internal combustion engine 25 supplies electrical energy for the traction drive 14 and various electric drives 27 of the treatment devices 4, 5. Additionally or alternatively, an electrical energy storage is also available in the track motor vehicle 2 to bridge interruptions in the overhead contact line 13.

Advantageously, there is a wireless data connection 28 between the autonomously operated trailer wagon 3 and the track motor vehicle 2. For example, control commands from a higher-level control device 29 are transmitted via this data connection 28 in order to coordinate automated operation of the two wagons 2, 3.

During coupled operation, the higher-level control device 29 is used to jointly control the energy supply device 15 and the energy storage device 16 in order to control or regulate the exchange of electrical energy. Advantageously, the entire rail vehicle 1 can be supplied with electrical energy from the energy storage device 16 of the trailer wagon 3 when the coupling is in place, as shown in FIG. 4. In this way, exhaust-free operation is ensured even without a separate energy storage in the track motor vehicle 2 when the overhead contact line 13 is absent or switched off. The rail vehicle 1 can be designed for work assignments with regular use of this operating mode by increasing the size of the energy storage device 16 accordingly.

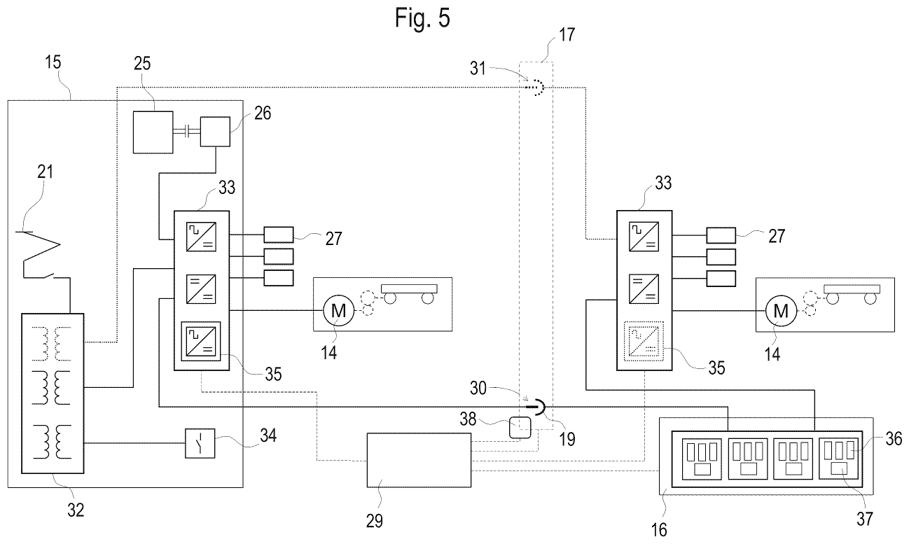

The block diagram in FIG. 5 shows an exemplary circuit of the energy supply device 15 and the energy storage device 16. In the illustration, the trailer wagon 3 is coupled to the track motor vehicle 2, with an electrical connection 30 being arranged for transmitting electrical energy. In one variant, a further electrical connection 31 is provided as an alternative or supplement.

The track motor vehicle 2 is preferably supplied from the overhead contact line 13 via the pantograph 21. Alternatively, it can be supplied by means of the generator 26. In the first case, a transformer circuit 32 is connected to the overhead contact line 13 by means of the pantograph 21. An output of the transformer circuit 32 is connected to the input of an converter circuit 33 of the track motor vehicle 2. There is also a connection between the transformer circuit 32 and an earthing module 34. In the second case, the converter circuit 33 is connected to the generator 26.

The converter circuit 33 comprises inverters and rectifiers for converting alternating or three-phase current into direct current and vice versa. Additionally, in the variant shown with continuous lines, the converter circuit 33 comprises a charging circuit 35 for the energy storage device 16 of the trailer wagon 3. An alternative is shown with dotted lines, in which the charging circuit 35 is arranged in a converter circuit 33 of the trailer wagon 3.

The electric traction drives 14 and working drives 27 of the treatment devices 4-8 are connected to the converter circuits 33 of the track motor vehicle 2 and the trailer wagon 3. The energy storage device 16 is connected to the charging circuit 35 in the track motor vehicle 2 via the electrical connection 30. In the variant shown with dotted lines, there is a connection with the charging circuit 35 arranged in the trailer wagon 3.

The energy storage device 16 comprises several battery cells 36 with their own charging electronics 37. A battery management system comprising the charging electronics 38 and the charging circuit 35 is set up to monitor, control, and protect the battery cells 37. A coordinated control of the interacting circuit elements 33, 35, 37 is advantageously achieved by means of the higher-level control device 29. Here, the coupling device 17 comprises a sensor device 38, which signals to the control device 29 whether there is a coupled state. In this way, the corresponding operating mode is activated by means of the control device 29 during an automated coupling process or an automated decoupling process.

During standard operation, the energy storage device 16 is charged in the coupled state by means of the energy supply device 15 of the track motor vehicle 2. After decoupling the trailer wagon 3 from the track motor vehicle 2, the traction drive 14 and the working drives 27 of the trailer wagon 3 are supplied from the energy storage device 16. The capacity of the energy storage device 16 is designed for an application that requires a maximum operating time in the decoupled state.

1: A method for carrying out work on a railway track by means of a rail vehicle, comprising a track motor vehicle with at least one electrically operable treatment device and an energy supply device for providing electrical energy, as well as a trailer wagon coupled to the track motor vehicle with an energy storage device for providing electrical energy, with the rail vehicle being driven to a track point to be treated, with the trailer wagon being decoupled from the track motor vehicle, and with the track point to be treated being treated by means of the track motor vehicle, wherein before and/or after treatment by means of the track motor vehicle, the track point is treated by means of the trailer wagon by supplying an electric traction drive of the trailer wagon and a treatment device of the trailer wagon with electrical energy from the energy storage device.

2: The method according to claim 1, wherein the track motor vehicle is supplied with electrical energy from an overhead contact line via a pantograph.

3: The method according to claim 1, wherein the energy storage device of the trailer wagon is charged in the coupled state via the energy supply device of the track motor vehicle.

4: The method according to claim 1, wherein the trailer wagon designed as a ballast regulating machine is used to produce a desired ballast profile during a track treatment operation.

5: The method according to claim 1, wherein sleepers are tamped during a track treatment operation using the track motor vehicle designed as a tamping machine and that the entire tamping machine, in particular, is moved forwards cyclically.

6: The method according to claim 1, wherein the trailer wagon is decoupled from the track motor vehicle during a treatment operation by means of an automatically and/or remotely controlled coupling device and is recoupled to the track motor vehicle after track treatment has been carried out.

7: The method according to claim 1, wherein control data is exchanged via a wireless data connection between the track motor vehicle and the trailer wagon.

8: The method according to claim 1, wherein the entire rail vehicle is supplied with electrical energy from the energy storage device of the trailer wagon during coupled operation.

9: A rail vehicle for carrying out a method according to claim 1, comprising a track motor vehicle with at least one electrically operable treatment device and an energy supply device for providing electrical energy as well as a trailer wagon with an energy storage device for providing electrical energy, wherein the trailer wagon comprises its own traction drive and its own electrically operable treatment device.

10: The rail vehicle according to claim 9, wherein the trailer wagon is designed as a ballast regulating machine, which in particular comprises a centre plough, a shoulder plough, a sweeper brush, and a ballast hopper.

11: The rail vehicle according to claim 9, wherein the track motor vehicle is designed as a tamping machine, which is intended in particular for cyclic forward movement from sleeper to sleeper.

12: The rail vehicle according to claim 9, wherein an automatically and/or remotely controlled coupling device with mechanical connecting elements and with electrical connecting elements is arranged for coupling the trailer wagon to the track motor vehicle and that, in particular, such a coupling device is arranged on both ends of both the track motor vehicle and the trailer wagon.

13: The rail vehicle according to claim 12, wherein a central buffer coupler with an electric interface is arranged as a coupling device.

14: The rail vehicle according to claim 1, wherein the track motor vehicle comprises a pantograph for the electrical energy supply from an overhead contact line.

15: The rail vehicle according to claim 9, wherein the track motor vehicle comprises an internal combustion engine and a generator coupled thereto for electrical energy supply.
